(19) United States
(12) Patent Application Publication
(10) Pub. No.: US 2014/0159807 A1
(43) Pub. Date: Jun. 12, 2014

(54) MULTIPLE-CLOCK, NOISE-IMMUNE SLICER WITH OFFSET CANCELLATION AND EQUALIZATION INPUTS

(71) Applicant: LSI CORPORATION, Milpitas, CA (US)

(72) Inventors: Yehui Sun, Shanghai (CN); Zhuo Gao, Beijing (CN); Lijun Li, Milpitas, CA (US); Freeman Y. Zhong, San Ramon, CA (US)

(73) Assignee: LSI CORPORATION, Milpitas, CA (US)

(21) Appl. No.: 13/707,873

(22) Filed: Dec. 7, 2012

(51) Int. Cl. G05F 1/10

(52) U.S. Cl. CPC G05F 1/10
USPC 327/538

(57) ABSTRACT

A slicer circuit including an input differential is configured to amplify an input reference voltage received at a pair of differential input nodes and provide a differential output voltage at a pair of differential output nodes, and a regeneration latch configured to amplify the differential output voltage. A differential offset compensation voltage is applied to the differential output voltage to provide DC-offset cancellation. A differential equalization voltage is applied to the differential output voltage to provide DFE equalization. A timing scheme employing multiple clocks provides reduced sampling-window width and increased output-signal width. Cross-coupled transistors are used to cancel kickback noise received at the differential output nodes.

### BACKGROUND

As data transmission rates continue to increase with technological advancements, high-speed parallel data transmission in backplane and other interconnect applications corrects for the effects of noise and other interference by serializing parallel data before transmission and then de-serializing the data upon reception. To achieve the transition between parallel and serial data transmission, devices referred to as serializer/deserializer (SERDES) devices are typically incorporated at both the transmitting and receiving ends of the serial data stream.

A SERDES device is a common transceiver that typically transmits data over a backplane via a point-to-point high-speed connection. In most applications, a SERDES device is configured for duplex transmission, where each node performs both serialization (transmission) and deserialization (reception). Hence, in a typical application, a SERDES device generally comprises at least one receiver and transmitter pair in the same core. A SERDES receiver receives serialized signals transmitted from a remote transmitter over a transmission channel and deserializes the data by converting the data into parallel format so that the data may be further processed. A SERDES transmitter receives parallel data from the internal core and serializes it for transmission to a remote receiver over the transmission channel.

In some SERDES devices, a slicer block is used to sample the input signal using a “clean” clock signal from the receive side (e.g., a back-end digital system) so that the external input data is re-timed (or “quantized”) according to the clock timing of the receive side. The slicer block is also used to increase the relatively-small amplitude of the input signal to a larger amplitude, typically to a rail-to-rail level or “CMOS level” (i.e., using power voltage to represent logic one and ground voltage to represent logic zero, as in CMOS logic), so that it can be received by the back-end digital system.

As data rates increase in modern digital communications, the corresponding input signals to the slicer tend to degrade so as to have an increasingly-smaller amplitude. Further input-signal degradation results from kickback noise caused by the slicer itself, which has a parasitic capacitance whose value tends to increase with process development. Additionally, performance of the slicer block degrades as external noise increases in complex system environments.

### SUMMARY

In one embodiment, an integrated circuit includes a slicer circuit having an input differential pair and a regeneration latch. The input differential pair is configured to amplify an input reference voltage received at a pair of differential input nodes and provide a differential output voltage at a pair of differential output nodes. The input differential transistor pair has a timing governed by a first clock signal. The regeneration latch is configured to amplify the differential output voltage and has a timing governed by a second clock signal different from the first clock signal.

### BRIEF DESCRIPTION OF THE DRAWING FIGURES

In the accompanying drawings:

FIG. 1 is a schematic diagram of an exemplary slicer circuit consistent with one embodiment of the disclosure; and

FIG. 2 is a timing diagram illustrating the operation of the exemplary slicer circuit of FIG. 1.

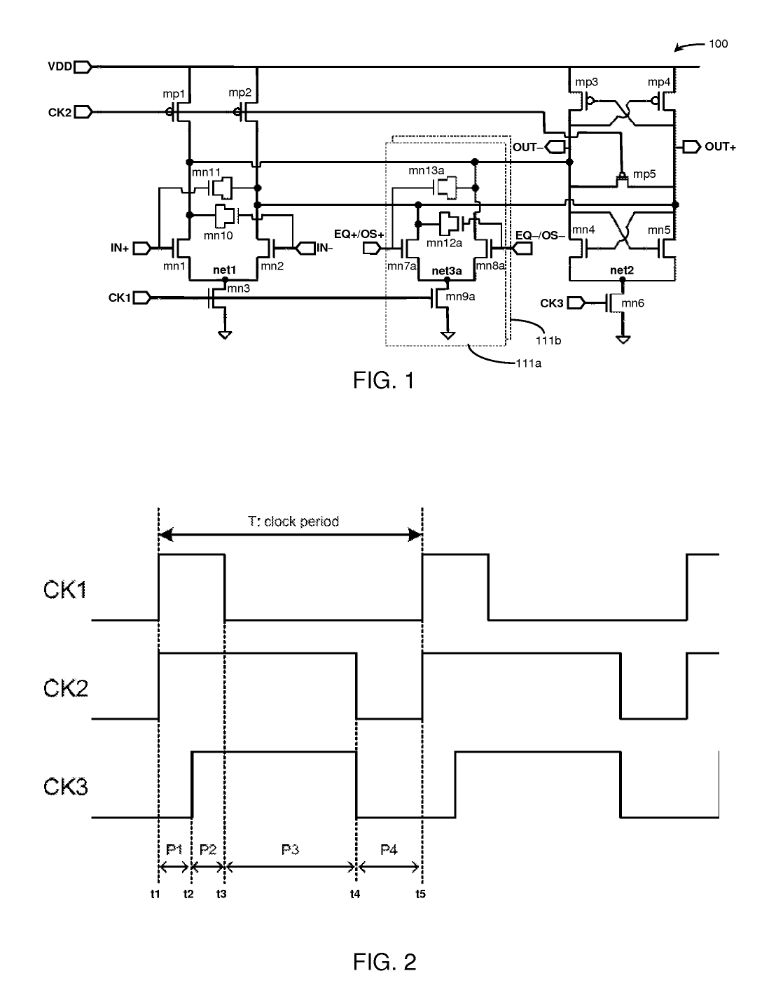

FIG. 1 shows a schematic diagram of an exemplary slicer circuit 100, in one embodiment of the disclosure. In this embodiment, circuit 100 includes p-type (e.g., PMOS) transistors mp1-mp5 and n-type (e.g., NMOS) transistors mn1-mn6, mn7a-mn9a, mn10, mn11, mn12a, mn13a, mn7b-mn9b, mn12b, and mn13b.

Differential offset compensation portion 111a of circuit 100 includes transistors mn7a-mn9a, mn12a, and mn13a. Although not explicitly shown in FIG. 1, differential equalization portion 111b of circuit 100 includes transistors mn7b-mn9b, mn12b, and mn13b arranged in like manner to the transistors of differential offset compensation portion 111a, as will be described in further detail below.

Transistors mn1 and mn2 form an input differential pair, which amplifies a differential input signal received at input nodes IN+, IN−. The differential input signal has a common-mode voltage determined by a previous-stage block (not shown).

Transistors mp3, mp4, mn4, and mn5 form a regeneration latch, which is a clock-enabled positive-feedback latch. During a regeneration phase, the regeneration latch amplifies the relatively small-amplitude input signal received at input nodes IN+, IN− to have a larger (e.g., rail-to-rail) amplitude, with the larger amplitude signal provided at output nodes OUT+, OUT−, at the CMOS level.

As shown in FIG. 1, the sources of transistors mn1 and mn2 and the drain of transistor mn3 are coupled to node net1. The sources of transistors mn4 and mn5 and the drain of transistor mn6 are coupled to node net2. The sources of transistors mn7a and mn8a and the drain of transistor mn9a are coupled to node net3a. The sources of transistors mn7b and mn8b and the drain of transistor mn9b are coupled to node net3b (not shown).

The first differential slicer input node IN+ is coupled to the gates of transistors mn1 and mn11. The second differential slicer input node IN− is coupled to the gates of transistors mn2 and mn10.

The first differential slicer output node OUT− is coupled to the drain of transistor mn1, the source and drain of transistor mn10, the drain of transistor mp1, the drain of transistor mp3, the gate of transistor mp4, the drain of transistor mp5, the drain of transistor mn4, the gate of transistor mn5, the sources and drains of transistors mn13a and mn13b, and the drains of transistors mn8a and mn8b.

The second differential slicer output node OUT+ is coupled to the drain of transistor mn2, the source and drain of transistor mn11, the drain of transistor mp2, the gate of transistor mp3, the drain of transistor mp4, the source of transistor mp5, the gate of transistor mn4, the drain of transistor mn5, the sources and drains of transistors mn12a and mn12b, and the drains of transistors mn7a and mn7b.

The sources of transistors mn3, mn6, mn9a, and mn9b are coupled to ground. The sources of transistors mp1, mp2, mp3, and mp4 are coupled to supply voltage VDD.

In differential offset compensation portion 111a of circuit 100, a first differential offset compensation node OS+ is coupled to the gates of transistors mn7a and mn13a, and a second differential offset compensation node OS− is coupled to the gates of transistors mn8a and mn12a. In differential equalization portion 111b of circuit 100, a first differential equalization node EQ+ is coupled to the gates of transistors mn7b and mn13b, and a second differential equalization node EQ− is coupled to the gates of transistors mn8b and mn12b. The signals at EQ+/EQ− and the signals at OS+/OS− desirably have the same common-mode voltage as input nodes IN+ and IN− to avoid introducing a voltage offset due to a common-mode mismatch between these three differential inputs of the slicer.

Three individual clock signals CK1, CK2, CK3 are supplied to circuit 100, an exemplary timing scheme for which is shown in FIG. 2 and discussed in further detail below. Signal CK1 is provided to the gates of transistors mn3, mn9a, and mn9b. Signal CK2 is provided to the gates of transistors mp1, mp2, and mp5. Signal CK3 is provided to the gate of transistor mn6.

### DC-Offset Compensation and DFE Equalization

Differential offset compensation portion 111a includes nodes OS+ and OS−, to which a differential offset compensation voltage is applied and thereby provided to transistors mn7a and mn8a, which are sized substantially the same as transistors mn1 and mn2. This differential offset compensation voltage is desirably selected to be equal to the DC offset of the input reference voltage applied to differential input nodes IN+ and IN−, to provide DC-offset cancellation when the differential offset compensation voltage is added to the input reference voltage.

In one embodiment, the following method, implemented by one or more components (not shown) residing outside of circuit 100, is used to determine an appropriate DC-offset compensation voltage to provide to nodes OS+ and OS−. First, the signals provided at IN+/IN− and EQ+/EQ− are all set to the common-mode voltage. Next, digital control logic sweeps the differential voltage of 0S+/OS− starting from the minus boundary value to the plus boundary value. At a certain differential OS value during the sweeping, the slicer output at nodes OUT+, OUT− should toggle, indicating that the input reference DC-offset value has been determined. The determined value is then provided, as an offset-compensation value, to nodes OS+ and OS−.

Differential equalization portion 111b includes nodes EQ+ and EQ−, to which a differential equalization voltage is applied and thereby provided to transistors mn7b and mn8b, which are sized substantially the same as transistors mn1 and mn2. This differential equalization voltage is desirably selected to provide decision-feedback equalization (DFE) when the differential equalization voltage is added to the input reference voltage at differential input nodes IN+ and IN−.

In one embodiment, one or more components (not shown) residing outside of circuit 100 are used during the normal operation of circuit 100 to determine an appropriate differential equalization voltage to provide to nodes EQ+ and EQ−. To accomplish this, the input signals provided at IN+/IN− are monitored and analyzed by a decision-feedback equalizer (DFE) that employs a DFE algorithm, which measures and analyzes tap delay values in the input signals. Tap-delay data from previous unit intervals is compared with current tap-delay data. For example, in one embodiment, a 10-tap DFE algorithm obtains tap delay values from the previous 10 unit intervals, separately applies a weight determined by the DFE algorithm to each of those 10 delay values, and sums the resulting values to obtain a resulting differential voltage that is provided to nodes EQ+ and EQ−.

The use of differential offset compensation portion 111a and differential equalization portion 111b of circuit 100 addresses the problem of input signals becoming smaller and input-reference offsets becoming larger due to higher regeneration-latch gain and ever-smaller device sizes being employed in high-speed applications, which would otherwise degrade slicer performance.

### Multiple-Clock Timing Scheme

Conventionally, a slicer employs a single clock signal with a 50% duty cycle, i.e., a sampling and regeneration phase occurring during the first half of the clock period, and a reset phase occurring during the second half of the clock period. To avoid the problem of degradation of the slicer output-signal quality due to voltage noise and data pattern-dependent jitter being introduced during the reset phase, circuit 100 increases noise immunity by employing a scheme with multiple distinct clocks CK1, CK2, and CK3.

As shown in FIG. 2, circuit 100 employs a clock period T divided into four phases, P1, P2, P3, and P4, in order to reduce the width of the sampling window and increase the width of the output signal relative to those widths associated with the 50% duty cycle of a conventional slicer.

The first phase, P1, is a sampling phase (having a width of approximately 0.1 T in FIG. 2). Phase P1 begins at time t1, when clock signal CK1 transitions to high, turning on transistors mn3, mn9a, and mn9b, thereby dropping the voltage at nodes net1, net3a, and net3b from high to ground. Also at time t1, clock signal CK2 transitions to high, turning off transistors mp1, mp2, and mp5.

The input voltages received at differential input nodes IN+ and IN− are amplified by input differential pair mn1, mn2 and are converted into two discharge currents. The first discharge current is on the branch between transistors mp1 and mn1, and the second discharge current is on the branch between transistors mp2 and mn2, as shown in FIG. 1.

Circuit 100 uses transistors mp1 and mp2 to charge the nodes OUT+ and OUT− during the reset phase (discussed in further detail below) and uses transistors mn1, mn2, and mn3 to discharge nodes OUT+ and OUT− during the sampling phase. The absolute values of the amplitudes of the two discharge currents will not be the same if the voltages at IN+ and IN− are different. It is noted that no sign information is used, because the two discharge currents have the same sign. The only differential is in the absolute values of the discharge currents, which will differ if the voltages at IN+ and IN− are different. For example, if IN+ is slightly higher than IN−, then the first discharge current will be smaller than the second discharge current, because a higher voltage at IN+ will cause the resistance at transistor mn1 to be higher than the resistance at transistor mn2.

When the voltage at node net3a drops to ground, differential offset compensation portion 111a begins to apply, to nodes OS+ and OS−, a differential offset compensation voltage, to provide DC-offset cancellation when the differential offset compensation voltage is added to the input reference voltage, as discussed in further detail above.

When the voltage at node net3b drops to ground, differential equalization portion 111b begins to apply, to nodes EQ+ and EQ−, a differential equalization voltage, to provide equalization when the differential equalization voltage is added to the input reference voltage, as discussed in further detail above.

The second phase, P2, is a combined sampling and (“weak”) regeneration phase (having a width of approximately 0.1T in FIG. 2). Phase P2 begins at time t2, when clock signal CK3 transitions to high, turning on transistor mn6, thereby dropping the voltage at node net2 from high to ground. The differential voltage (|(OUT+)−(OUT−)|) of output nodes OUT+, OUT− is amplified to the CMOS level by the regeneration latch formed by transistors mp3, mp4, mn4, mn5.

The third phase, P3, is a regeneration phase (having a width of approximately 0.6T in FIG. 2). Phase P3 begins at time t3, when clock signal CK1 transitions to low, turning off transistors mn3, mn9a, and mn9b, thereby raising the voltage at nodes net1, net3a, and net3b from ground to high, deactivating differential offset compensation portion 111a, differential equalization portion 111b, input differential pair mn1, mn2, and the regeneration latch formed by transistors mp3, mp4, mn4, mn5. During the regeneration phase, the regeneration latch amplifies the relatively small-amplitude input signal received at input nodes IN+, IN− to have a larger (e.g., rail-to-rail) amplitude, with the larger amplitude signal provided at output nodes OUT+, OUT−, at the CMOS level.

The fourth phase, P4, is a reset phase (having a width of approximately 0.2T in FIG. 2). Phase P4 begins at time t4, when clock signal CK2 transitions to low, turning on transistors mp1, mp2, and mp5, and turning off transistors mn3, mn6, and mn9. Also at time t4, clock signal CK3 transitions to low, turning off transistor mn6, thereby raising the voltage at node net2 from ground to high. Nodes OUT+ and OUT− are shorted by transistor mp5 and are tied to supply voltage VDD by transistors mp1 and mp2. The regeneration latch (mp3, mp4, mn4, and mn5) is disabled (i.e., disconnected from ground) by transistor mn6, and differential transistor pairs mn1, mn2 and mn7, mn8 are disabled (i.e., disconnected from ground) by transistors mn3 and mn9. The purpose of the reset phase is to clean up information associated with the previous bit and prepare for the next sampling operation.

Phase P4 ends at time t5, when clock signals CK1 and CK2 return to high, and phase P1 of the subsequent period T begins, as described above.

By employing multiple clock signals instead of a single clock signal, the sampling window width is reduced from 0.5T to 0.2T (i.e., the combined widths of P1 and P2) and the slicer receives less noise and has improved output jitter performance. Additionally, the output-signal width (i.e., the combined widths of P2 and P3) is increased from 0.5T to 0.7T, providing a more effective output-signal width.

The timing and widths of phases P1 through P4 are adjusted , in certain embodiments of the disclosure, using one or more of the following exemplary parameters (it should be understood that other timings, widths, and arrangements for multiple clock phases may alternatively be used in other embodiments):

The rising edges of clock signals CK1 and CK2 should be concurrent, and the pulse width of clock signal CK1 should be equal to the combined duration of phases P1 and P2.

The starting time of phase P1 is concurrent with the rising edges of clock signals CK1 and CK2, and the ending time of phase P1 is concurrent with the rising edge of clock signal CK2. The width of phase P1 should be equal to the discharge time of output nodes OUT+ and OUT− from VDD to a voltage that tends to maximize the gain of transistors mp3, mp4, mn4, and mn5 (which should be approximately VDD/2). Typical widths for phase P1 will be between approximately 0.05T and approximately 0.1T, such that the rising edge of clock signal CK3 should be between approximately 0.05T and approximately 0.1T later than the rising edges of clock signals CK1 and CK2.

The starting time of phase P2 is concurrent with the rising edge of clock signal CK3, and the ending time of phase P2 is concurrent with the falling edge of CK1. The width of phase P2 should be sufficient for the absolute differential output voltage (|(OUT+)−(OUT−)|) to increase from zero to its largest value (which should be approximately VDD/5). A typical width for phase P2 will be approximately 0.15T.

The starting time of phase P3 is concurrent with the falling edge of clock signal CK1, and the ending time of phase P3 is concurrent with the falling edge of clock signal CK2. The width of phase P3 should be equal to T less the combined durations of phases P1, P2, and P4.

The starting time of phase P4 is concurrent with the falling edge of clock signal CK3, and the ending time of phase P4 is concurrent with the next rising edge of clock signal CK1. The width of phase P4 should be sufficient for output nodes OUT+ and OUT− to be reset to VDD by transistors mp1 and mp2. Typical widths for phase P4 will be between approximately 0.1T and approximately 0.2T.

### Kickback-Noise Cancellation

In a conventional slicer, when the voltage of the output nodes changes at regeneration or reset time, a portion of the signal may be “kicked back” to the input nodes due to parasitic capacitance between the gates and drains of input NMOS differential-pair transistors mn1, mn2. This kickback noise from the output nodes distorts the input signal. Kickback cancellation is used to reduce the differences in magnitude at nodes IN+ and IN− that are caused by the kickback noise from nodes OUT+ and OUT−.

By employing cross-coupling NMOS devices mn10, mn11, mn12, mn13 between input nodes IN+, IN− and output nodes OUT+, OUT−, circuit 100 has the ability to cancel kickback noise from the output nodes. For example, when the voltages at output nodes OUT+ and OUT− change, noise through transistor mn1 is received from node OUT−, and noise through transistor mn11 is received from node OUT+. These two noise signals will cancel each other at input node IN+ because the voltages at OUT+ and OUT− have the same amplitude but opposite polarities. The sizes of the cross-coupling devices are desirably tuned such that the capacitance values between the gates and drains/sources of the cross-coupling devices match the parasitic capacitance values between the gates and drains of the transistors of the corresponding input differential pair.

As would be understood by those skilled in the art, circuit 100 provides differential offset compensation, differential equalization, a multiple-clock timing scheme that reduces the width of the sampling window and increases the width of the output signal to reduce noise and jitter, and provides kickback-noise cancellation. It should be understood that, in alternative embodiments of the disclosure, fewer than all of the foregoing features are present. For example, although FIG. 1 includes both differential offset compensation portion 111a and differential equalization portion 111b of circuit 100, in alternative embodiments, a circuit consistent with embodiments of the disclosure could alternatively employ only one, or neither, of portions 111a and 111b. As another example, fewer than the three clock signals CK1, CK2, CK3 of circuit 100 could alternatively be used in other embodiments of the disclosure.

In alternative embodiments, transistors mp1-mp5 are NMOS devices, and transistors mn1-mn6, mn7a-mn9a, mn10, mn11, mn12a, mn13a, mn7b-mn9b, mn12b, and mn13b are PMOS devices. Alternatively, one or more other switching and/or amplification devices could be used to achieve the same or similar functionality as one or more of the transistors of circuit 100.

Circuit 100 shows a device consistent with one embodiment of the disclosure. In a second embodiment, a circuit similar to circuit 100 is employed, but without any kickback-noise cancellation (e.g., by omitting cross-coupling NMOS devices mn10, mn11, mn12, mn13). In a third embodiment, a circuit similar to circuit 100 is employed, but without any DC-offset compensation and/or DFE equalization (e.g., by omitting one or more of differential offset compensation portion 111a and differential equalization portion 111b). In a fourth embodiment, a circuit similar to circuit 100 is employed, but without a multiple-clock timing scheme (e.g., using only a single clock signal with a 50% duty cycle, i.e., a sampling and regeneration phase occurring during the first half of the clock period, and a reset phase occurring during the second half of the clock period). In a fifth embodiment, only kickback-noise cancellation is employed, without any DC-offset compensation and/or DFE equalization, and without the use of multiple clocks. In a sixth embodiment, only DC-offset compensation and/or DFE equalization is employed, without any kickback-noise cancellation or the use of a multiple-clock timing scheme. In a seventh embodiment, only kickback-noise cancellation is employed, without DC-offset compensation and/or DFE equalization, and without a multiple-clock timing scheme.

Embodiments of the disclosure may be implemented as (analog, digital, or a hybrid of both analog and digital) circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro controller, general-purpose computer, or other processor.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

Signals and corresponding nodes or ports may be referred to by the same name and are interchangeable for purposes herein.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing embodiments of the disclosure. Embodiments of the disclosure can also be manifest in the form of program code, for example, stored in a non-transitory machine-readable storage medium including being loaded into and/or executed by a machine, wherein, when the program code is loaded into and executed by a machine, such as a computer, the machine becomes an apparatus for practicing embodiments of the disclosure. When implemented on a general-purpose processor, the program code segments combine with the processor to provide a unique device that operates analogously to specific logic circuits.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo-code, and the like represent various processes that may be substantially represented in a computer-readable medium and be executed by a computer or processor, whether or not such computer or processor is explicitly shown.

Unless explicitly stated otherwise, each numerical value and range should be interpreted as being approximate as if the word “about” or “approximately” preceded the value of the value or range.

It will be further understood that various changes in the details, materials, and arrangements of the parts (e.g., if appropriate, circuits, sub-circuits, and components) which have been described and illustrated in order to explain embodiments of the disclosure may be made by those skilled in the art without departing from the scope of the disclosure as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the disclosure.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

We claim:

1. An integrated circuit comprising a slicer circuit comprising:
an input differential pair configured to amplify an input reference voltage received at a pair of differential input nodes and provide a differential output voltage at a pair of differential output nodes, wherein the input differential transistor pair has a timing governed by a first clock signal; and
a regeneration latch configured to amplify the differential output voltage, the regeneration latch having a timing governed by a second clock signal different from the first clock signal.

2. The integrated circuit of claim 1, further comprising a differential offset compensation portion configured to receive a differential offset compensation voltage at a pair of differential offset compensation nodes and apply the differential offset compensation voltage to the differential output voltage.

3. The integrated circuit of claim 2, wherein the differential offset compensation portion has a timing governed by the first clock signal.

4. The integrated circuit of claim 1, further comprising a differential equalization portion configured to receive a differential equalization voltage at a pair of differential equalization nodes and apply the differential equalization voltage to the differential output voltage.

5. The integrated circuit of claim 4, wherein the differential equalization portion has a timing governed by the first clock signal.

6. The integrated circuit of claim 1, wherein:
the slicer circuit has a clock period T; and
the first clock signal implements an input reference-voltage sampling window having a width less than 0.5T.

7. The integrated circuit of claim 1, wherein:
the slicer circuit has a clock period T; and
the first clock signal implements a differential output voltage having a signal width greater than 0.5T.

8. The integrated circuit of claim 1, further comprising one or more cross-coupled transistors configured to cancel kickback noise received at the differential output nodes.

9. The integrated circuit of claim 1, wherein the slicer circuit has a clock period T comprising: (i) a sampling phase, (ii) a combined sampling and regeneration phase, (iii) a regeneration phase, and (iv) a reset phase.

10. The integrated circuit of claim 1, wherein the slicer circuit has a clock period T comprising a reset phase having a timing governed by a third clock signal different from the first and second clock signals.

11. A method for processing an input reference voltage to provide a differential output voltage, the method comprising:
(a) amplifying an input reference voltage received at a pair of differential input nodes to provide a differential output voltage at a pair of differential output nodes, the timing of step (a) governed by a first clock signal; and
(b) amplifying the differential output voltage, the timing of step (b) governed by a second clock signal different from the first clock signal.

12. The method of claim 11, further comprising:
(c) receiving a differential offset compensation voltage at a pair of differential offset compensation nodes; and
(d) applying the differential offset compensation voltage to the differential output voltage.

13. The method of claim 12, wherein the timing of step (d) is governed by the first clock signal.

14. The method of claim 11, further comprising:
(c) receiving a differential equalization voltage at a pair of differential equalization nodes; and
(d) applying the differential equalization voltage to the differential output voltage.

15. The method of claim 14, wherein the timing of step (d) is governed by the first clock signal.

16. The method of claim 11, wherein:
steps (a) and (b) occur during a clock period T; and
the first clock signal implements an input reference-voltage sampling window having a width less than 0.5T.

17. The method of claim 11, wherein:
steps (a) and (b) occur during a clock period T; and
the first clock signal implements a differential output voltage having a signal width greater than 0.5T.

18. The method of claim 11, further comprising cancelling kickback noise received at the differential output nodes using one or more cross-coupled transistors.

19. The method of claim 11, wherein:
steps (a) and (b) occur during a clock period comprising: (i) a sampling phase, (ii) a combined sampling and regeneration phase, (iii) a regeneration phase, and (iv) a reset phase.

20. The method of claim 11, wherein:
steps (a) and (b) occur during a clock period T comprising a reset phase having a timing governed by a third clock signal different from the first and second clock signals.
